(19) United States
(12) Patent Application Publication
(10) Pub. No.: US 2004/0213557 A1
(43) Pub. Date: Oct. 28, 2004

(54) NON-HIERARCHICAL INTERFACE SCREENS FOR USE IN A VIDEO RECORDER

(75) Inventors: Haig H. Krakirian, Burbank, CA (US); Jim A. Bumgardner, Shadow Hills, CA (US)

Correspondence Address: DVA / PIONEER DIGITAL TECHNOLOGIES, SUITE 200, 2355 MAIN STREET, IRVINE, CA, 92614, US

(73) Assignee: PIONEER DIGITAL TECHNOLOGIES, INC., Burbank, CA (US)

(21) Appl. No.: 10/604,538

(22) Filed: Jul. 29, 2003

Related U.S. Application Data
(63) Continuation-in-part of application No. 10/249,605, filed on Apr. 23, 2003.

(51) Int. Cl. H04N 7/52

(52) U.S. Cl. 386/108

(57) ABSTRACT

The present invention is directed to non-hierarchical interface screens for use with a video recorder. The present invention includes a set-top box having an internal storage device, such as a hard drive where broadcasts are transferred from a broadcast input source to the storage device and can later be retrieved from the storage device for viewing. The set-top box is connected to an output device such as a television, which displays a graphical user interface (GUI) and an interactive program guide (IPG). The GUI also allows the user to access several core interface screens that all correspond to specific buttons on an input device, such as a remote control. The user is able to access any of the core interface screens without navigating through a hierarchically arranged series of interface screens.

### CROSS REFERENCE TO RELATED APPLICATIONS

This Application is a continuation in part of the patent application Ser. No. 10/249,605 entitled Storage Manager for a Video Recorder, filed Apr. 23, 2003.

### COPYRIGHT STATEMENT

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF INVENTION

1. Field of the Invention

The present invention relates generally to systems that operate on broadcast content, and in particular to schemes for managing the contents of storage devices where the broadcast content resides.

2. Background of the Invention

The storage and retrieval of broadcast content gained major popularity with the advent of the VCR. A user was able to tune their television to a station that had a program that they wanted to save and they simply inserted a storage device (e.g., VHS tape), moved the tape to the appropriate location, and began capturing the broadcast. Recently, other types of equipment have developed to perform similar functionality. These types of equipment include, for instance, DVD recorders (DVD-R) and set-top boxes that transfer the content to storage devices such as hard drives and buffer memory.

Both of these types of equipment are used in a manner that is similar to the manner in which VCRs are used. Each has its own storage device (i.e., a DVD or hard drive) and each storage device is of finite space. If a user is saving a long show, multiple shows, or begins saving the show when the storage device is nearly full, there is a chance that the program the user is trying to save will be lost if the device overflows. This is a frustrating problem for the average user, specifically when they want to save content when they are away from the home.

Saving Broadcast Content

Saving broadcast content in its simplest form comprises turning on a television set and pressing a record button on a VCR. More recently, VCRs, DVD recorders, set-top boxes with hard drives, and other storage devices include interfaces, which allow users to schedule the transfer of shows at a later date or time. Using this interface, the user is able to input to the device a time and a channel, and at the appropriate time the device tunes to the channel and begins saving the show. This is useful, for instance, when the user is away from home and wants to see the show later.

Another modern interface allows the user to focus on a favorite show, a favorite timeslot, or a favorite genre. For instance, a user may love Monday Night Football, which occurs every Monday night from 6:00 P.M to 9:00 P.M. So, the user may wish to transfer this broadcast to a storage device regardless of whether they are home or not. Using the interface, the user is able to set the system to save content for the three hours on Monday night every time the football game is broadcast.

However, these schemes suffer from the same drawback as the most simple, manual recording scenario. Namely, since the storage medium for all of these devices is finite, there is always the risk that the medium will run out of space (or overflow). When this happens, these devices offer no mechanism that is able to either: save the currently recorded broadcast; rewind the medium and start recording at the beginning of the medium; or to make a determination of whether the currently scheduled recording should replace any of the previously saved shows.

Circular Buffer

One solution is to use a circular buffer. Using a circular buffer, some prior art schemes begin recording over the beginning of the medium once the buffer is full. This allows a user to avoid missing a program that might have its transfer initiated near the end of the medium. This solution, however, is inadequate for a number of reasons. First, there is no guarantee that the data at the beginning of the circular buffer (i.e., the oldest data) is not more important to the user than the data that is currently being transferred to the storage device. In this instance, the circular buffer is more problematic even than a VCR tape that simply stops at the end of the tape, since in this case, the important show at the beginning of the tape is not lost. Moreover, it becomes very difficult to manage the shows that a user wishes to keep that are at an intermediate portion of the circular buffer, since the buffer starts being overwritten automatically and it is difficult to predict in advance when an intermediate show will occur in the circular buffer.

### SUMMARY OF INVENTION

The present invention is directed to non-hierarchical interface screens for use with a video recorder. The present invention includes a set-top box having an internal storage device, such as a hard drive where broadcasts are transferred from a broadcast input source to the storage device and can later be retrieved from the storage device for viewing. The set-top box is connected to an output device such as a television, which displays a graphical user interface (GUI) and an interactive program guide (IPG).

The IPG uses guide data that comprises information about shows (such as times when shows are broadcast, titles of the shows, descriptions of the shows, etc.,) that are available by tuning to different channels at different times. The GUI allows the user to navigate through the IPG, for instance, by viewing different times and dates for broadcasts. The GUI also allows the user to access a storage status screen that provides: what shows currently reside on the disk; what shows are scheduled to be transferred to the disk in the future; the relative location of the saved shows on the disk; estimates of how long it will be before certain saved shows are erased from the disk to make room for newly scheduled shows; an identification the amount of time a saved show is set to remain on the disk by viewing graphical icons; and the priorities of the saved shows on the disk.

In one embodiment, a priority is assigned to each saved show on the disk. As the disk fills and approaches the point where it will overflow, the video recorder deletes the lowest priority shows to make space for a current show. In another embodiment, the video recorder anticipates when the lowest priority show will soon be erased and provides a notification to the user. Using the GUI, the user can reassign priorities to save the current show, stop an active transfer of a show, or do nothing in response.

Using the GUI, the user may change the priorities of the shows either explicitly or by dragging and dropping saved shows in the GUI toward the front or back of a saved shows list thereby extending or reducing their time before being erased from the disk. In one embodiment, the saved show list is handled as a data structure, such as a queue, array, or linked list that is used in a first-in, first-out (FIFO) manner when a show must be removed to avoid an overflow. The location of a show in the data structure identifies the relative priority of the show in relation to the other shows. When the user drags and drops a show to a different location in the saved show list, the system reorganizes the data structure to correspond to the action taken in the GUI.

In another embodiment of the present invention, algorithms are used to estimate the time until a show is deleted. One algorithm uses a precise method of estimating the time until deletion, taking into account for automatically scheduled series and also the automatic deletion of surplus episodes. When a precise method is not possible, another algorithm is initiated to find an inexact estimated time until deletion.

### BRIEF DESCRIPTION OF DRAWINGS

The invention will be more fully understood by reference to the following drawings, which are for illustrative purposes only:

FIG. 1 is a functional block diagram of an embodiment of a set-top box.

FIG. 2 is a block diagram of a configuration for one of the multiple tuners associated with a video recorder.

FIG. 3 is a block diagram of a configuration for a single decoder.

FIG. 4 is a block diagram of a typical tuner arrangement for use with a live TV signal.

FIG. 5 is a block diagram of a typical tuner arrangement for use when transferring a signal.

FIG. 6 is a block diagram of an arrangement for when a user is watching a show that has completed being transferred to a storage device.

FIG. 7 is a block diagram of an arrangement for when a user is watching a show that was previously transferred to a storage device while another show is actively being transferred.

FIG. 8 is a flowchart describing a storage management process according to one embodiment of the invention.

FIG. 9 is a flowchart showing a storage management process according to another embodiment of the invention.

FIG. 10 is a flowchart showing a storage management process according to another embodiment of the invention.

FIG. 11 is an example of a saved shows screen according to one embodiment of the present invention.

FIG. 12 is an example of a storage priority screen according to one embodiment of the present invention.

FIG. 13 is a flowchart showing a disk-space clearing algorithm according to one embodiment of the present invention.

FIG. 14 is a flowchart showing a disk-space clearing algorithm according to another embodiment of the present invention.

FIG. 15 is a diagram that provides an overview of the screens, menus, and functions that are provided for the user according to an embodiment of the present invention.

FIG. 16 is a block diagram showing an embodiment of an overall video recorder system that includes a set-top box.

FIG. 17 is a flowchart showing a precise method for estimating the time until deletion according to one embodiment of the present invention.

FIG. 18 is a flowchart showing a method for estimating the time until deletion for a series including the use of surplus episodes according to one embodiment of the present invention.

FIG. 19 is a flowchart showing an inexact method for estimating the time until deletion according to one embodiment of the present invention.

FIG. 20 is a prior art hierarchical interface screen.

FIG. 21 is a non-hierarchical screen according to an embodiment of the present invention.

FIG. 22 shows a saved shows screen according to one embodiment of the present invention.

FIG. 23 shows a recording schedule screen according to one embodiment of the present invention.

FIG. 24 shows a series manager screen according to one embodiment of the present invention.

FIG. 25 shows a series manager screen in prioritize mode according to one embodiment of the present invention.

FIG. 26 is a diagram of an input device used by an embodiment of the present invention.

FIG. 27 is a priority picker for a saved shows screen according to an embodiment of the present invention.

### DETAILED DESCRIPTION

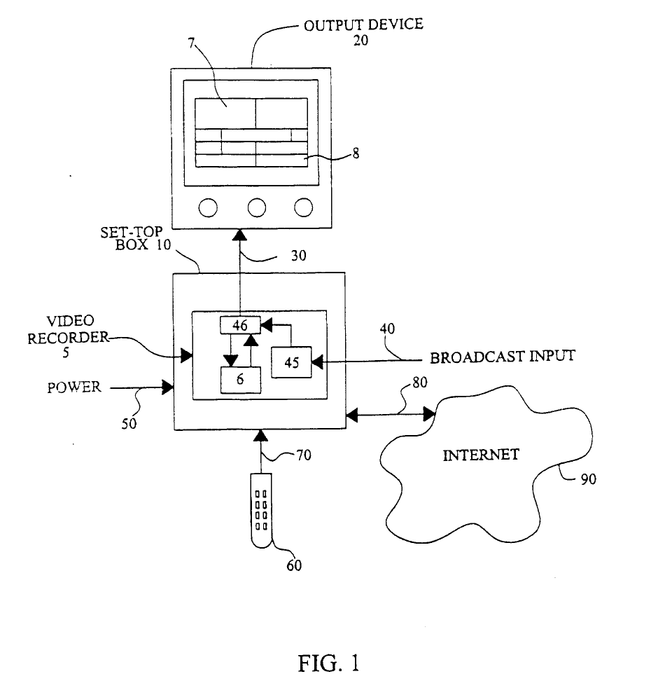

The present invention relates to non-hierarchical interface screens for use with a video recorder. Referring more specifically to the drawings, for illustrative purposes an embodiment of a video recorder, also referred to as a personal video recorder (PVR) or digital video recorder (DVR), is shown in the functional block diagram of FIG. 1.

A video recorder (or PVR) is an internal or external component that works in conjunction with a set-top box that is used to watch television. The PVR includes some or all of a combination of software, hardware, and firmware. In one embodiment, the PVR 5 uses a disk drive storage device 6 that is internal to a set-top box 10 where broadcasts are transferred to the storage device 6. The set-top box 10 connects to an output device 20, which facilitates the use of broadcast signals, such as live television signals, video on demand broadcasts, downloads of Internet content, viewing of web pages, and viewing of content transferred to the storage device. In the example of FIG. 1, set-top box 10 is shown as being external to output device 20. It should be understood by someone having ordinary skill in the art, that set-top box 10 may be internal to output device 20 as well.

A graphical user interface (GUI) 7, which includes an IPG 8 is provided and is selectively displayed on the output device 20, for instance when a user presses a specific button on a remote control 60. GUI 7 in conjunction with IPG 8 allows the user to control the PVR 5. The software or firmware that controls set-top box 10 may be installed locally or it may be downloaded from the Internet 90 as needed when configuring new set-top boxes or when updating existing ones. Set-top box 10 is connected to output device 20 via a transmission line 30. Broadcast signals are received by the set-top box 10 via transmission line 40, which may be connected to either an antenna, a cable television outlet or a satellite connection.

One or more tuner systems 45 are configured to allow the system to receive broadcast signals from multiple channels simultaneously up to the given number of tuners. As the broadcast input signal enters the system along line 40, it is tuned by one of the tuners 45 and transferred to volatile memory 46, which might include RAM, ROM, cache memory, or other volatile memory source. Volatile memory 46 might include a buffering mechanism, such as a circular or linked list buffer that allows a user to view a delayed live broadcast. The broadcast content is transferred to storage device 6 if it is saved permanently. Storage device 6 may eventually become almost full or near a state of overflow if too much content has been saved. When the state of overflow is imminent, the system is configured to remove one or more shows from storage device 6 based on a number of factors. The size of storage device 6 is also used to determine when it will overflow and to estimate the time until a show on storage device 6 needs to be deleted. Set-top box 10 receives power through a line 50.

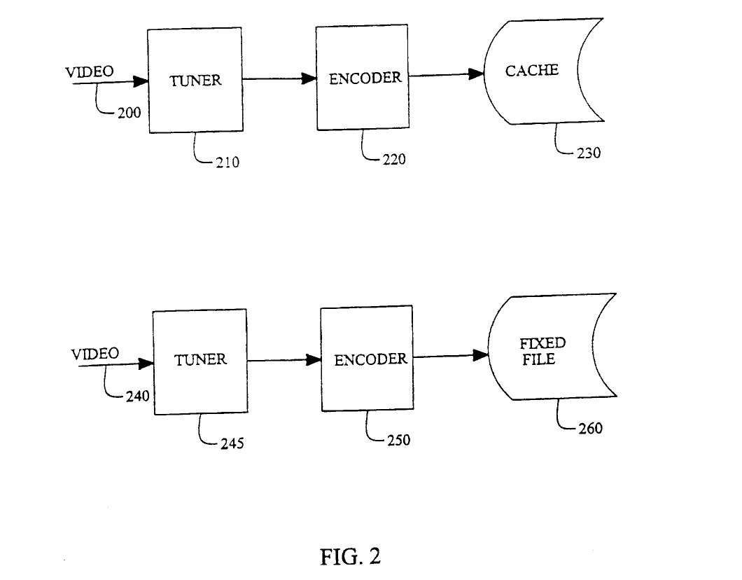

Set-top box 10 receives user input entered from handheld remote control 60 over a wireless link 70. Wireless link 70 may be an infrared (IR) link, a radio frequency (RF) link, or any other suitable type of link. A bi-directional data path 80 is provided to set-top box 10, through which set-top box 10 can access the Internet 90. Transmission line 40 may provide data from a variety of input sources including cable, satellite, or electro-magnetic waves. In one embodiment of the present invention, the PVR uses multiple tuners. Each of the tuners is normally associated with one encoder and one cache, which may be a fixed or variable size cache (for a live signal) or a fixed file in the case where the incoming signal is transferred to the storage device. FIG. 2 shows various configurations for one of the multiple tuners associated with the PVR. Video stream 200 is provided to tuner 210, which passes the signal to encoder 220, which transfers the data in a cache 230. This configuration is used for analog use of a live TV signal. Cache 230 may be any memory technique known to those skilled in the art. One embodiment implements a linked list in the cache wherein a live signal is added to the linked as individual frames and as the buffer fills the older frames at the end of the list are released from the list and re-allocated to a cache allocation system.

An alternate configuration includes a video stream 240, which is then provided to tuner 245, which is then passed to encoder 250 and then to fixed file block 260. This configuration is useful for the analog transfer of a signal. For digital channels, encoder blocks 220 and 250 are removed, since the signal has already been digitized.

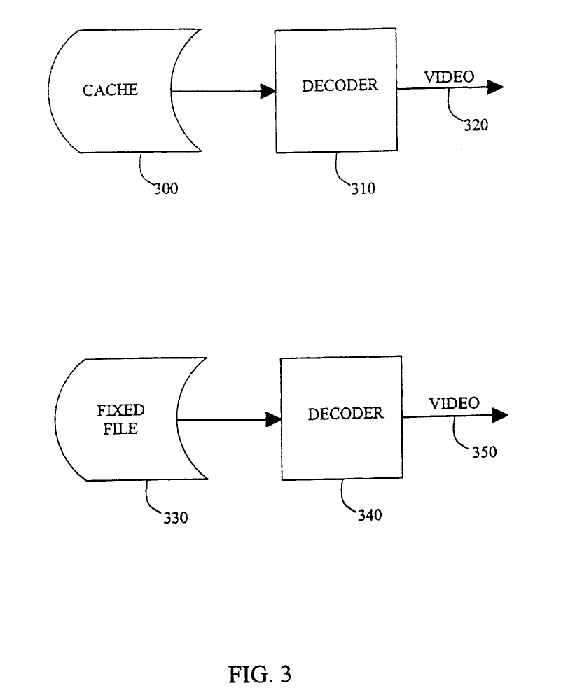

FIG. 3 shows a configuration for a single decoder. Cache 300 provides data to decoder 310, which outputs video signal 320. This arrangement is useful for watching live TV. Alternatively, fixed file block 330 provides data to decoder 340, which outputs a video signal 350. This embodiment is useful for playing back a show that has already been transferred to the storage device.

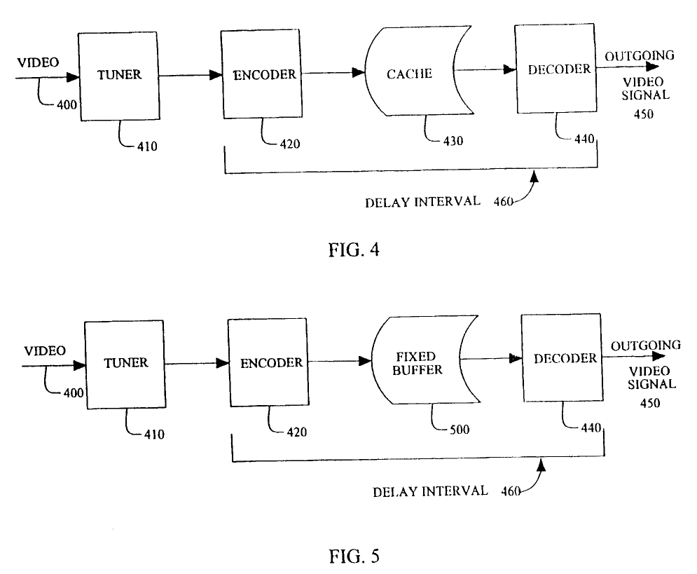

Each decoder shown in FIG. 3 is associated with a tuner/encoder pair. For a live TV signal, FIG. 4 shows an example of a typical arrangement, where video signal 400 is transmitted to tuner 410 then to encoder 420 and to cache 430. After it leaves cache 430 it is decoded in block 440 and the outgoing video signal 450 is displayed on the television. It should be noted that a delay interval 460 of a given (x) number of seconds occurs between the time the signal reaches encoder 420 and is output by decoder 440. Therefore, a live TV signal is typically a signal that has been delayed by (x) seconds. If a user is watching a program and is currently transferring the program to a storage device as well, a cache, as shown in block 430 of FIG. 4 is not used. Instead, a fixed buffer 500, shown in FIG. 5 is used.

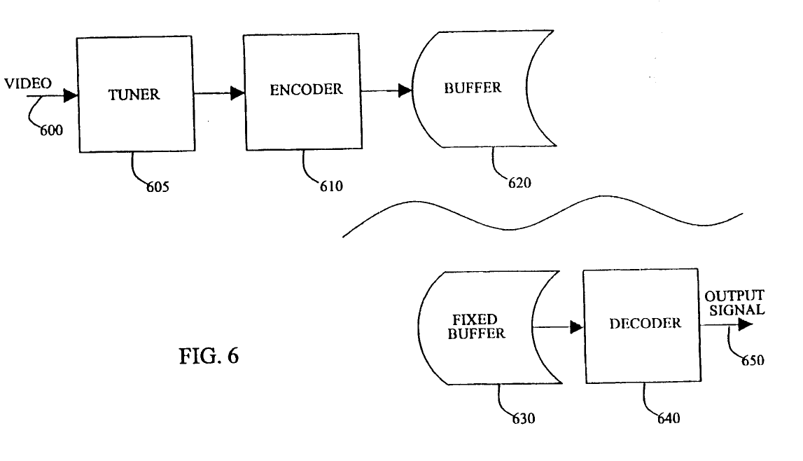

If the user is watching a show that has already been transferred to the storage device, the decoder is decoupled from the encoder (i.e., it reads from a different cache than the encoder), which continues to encode and cache the live video signal. This embodiment is shown in FIG. 6, where video signal 600 is tuned at block 605 and encoded at block 610 and stored in buffer 620. Fixed buffer 630 is used to provide data to decoder 640, which provides the output signal 650.

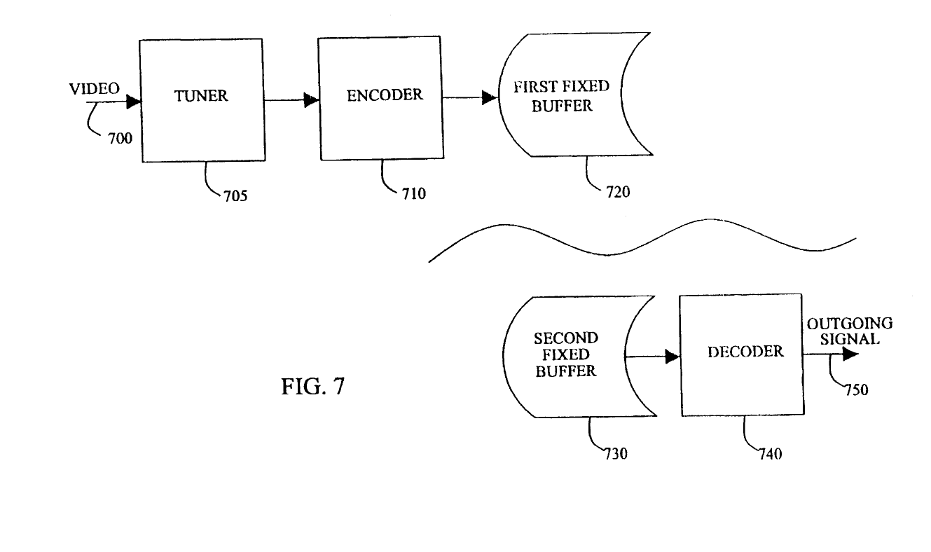

Finally, if a user is watching a show that resides already on the storage device while another show is currently being transferred to the storage device, two different fixed buffers are implemented. This embodiment of the present invention is shown in FIG. 7. Video signal 700 is tuned at block 705 and encoded at block 710 and stored in a first fixed buffer 720. A second fixed buffer 730 is used to watch the previously saved show, by transmitting and decoding the data at block 740 and displaying the output video signal 750 on a television.

According to an embodiment of the present invention, a set-top box has an internal hard drive for the storage of shows that are transferred there when they are broadcast. The set-top box is connected to or is integrated with an output device such as a television. Using the television, a user interacts with a graphical user interface (GUI) and an interactive program guide (IPG). The IPG has data for all of the shows broadcast on the various channels. The IPG data includes, for instance, the show title, the time the show starts, the time the show ends, a description of the show at various levels of detail, etc.

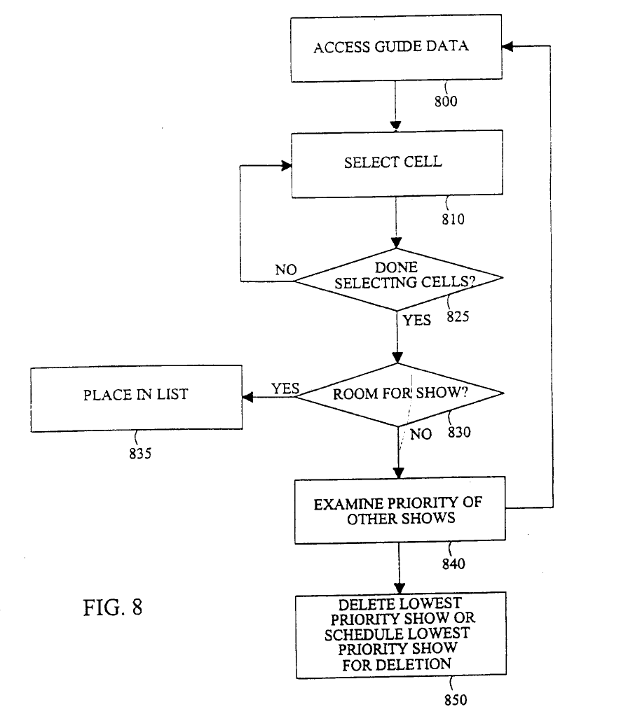

The GUI allows the user to navigate through the IPG data, for instance, by viewing different times and dates for broadcasts. The GUI also allows the user to view and manipulate the disk contents. In one embodiment, a priority is assigned to each saved show. As the disk fills towards the point of overflow, the PVR deletes the lowest priority saved shows to make space for the show that is actively being transferred or scheduled to be transferred. This embodiment of the present invention is shown in FIG. 8. At block 800, a user accesses the guide data in the IPG using a GUI. At block 810 the user selects a cell in the IPG corresponding to the program or show to transfer to the storage device. At block 825, it is determined if the user is done selecting cells. If not, block 810 repeats. When the user is done selecting cells, the system determines if the disk has room for the scheduled show at block 830.

If so, the show is placed in a list at block 835. The list comprises all of the shows that have already been transferred to the storage device or are scheduled to be transferred to the storage device in the future. If block 830 is false (i.e., the disk does not have enough room for the show), then at block 840 each saved show on the disk has its priority examined. At block 850, the lowest priority show is deleted or scheduled for deletion, when the disk space is needed for the newly selected cell.

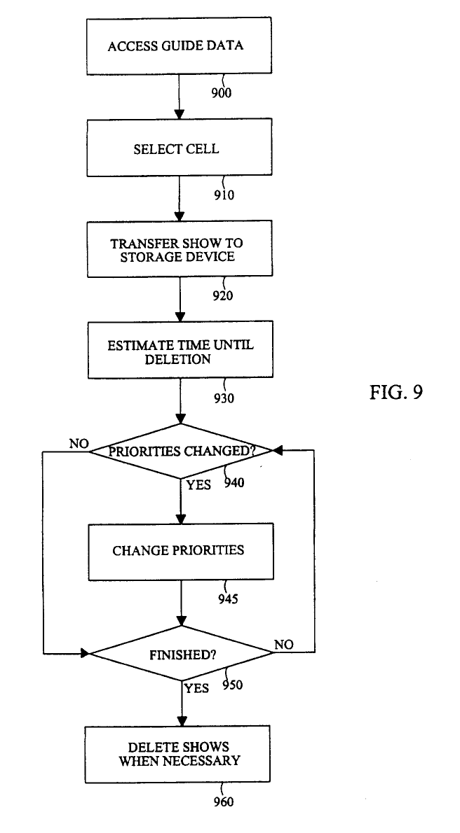

Another embodiment of the present invention allows the user to manually control the contents of the disk. This embodiment is described in connection with the flowchart in FIG. 9. At block 900, a user accesses guide data in the IPG using a GUI. At block 910 the user selects a cell in the IPG corresponding to the show to be transferred to a storage device. At block 920, the show represented by the cell is transferred to a storage device.

After the system has transferred the show, it analyzes the amount of available disk space and the priority of each saved show and from this at block 930 determines a date and time that each selected show will eventually be deleted. At block 940, the user interacts with the GUI wherein they may change the priorities of the programs manually at block 945 after reading the eventual deletion date and time. This includes, for instance, making a show un-deletable, raising its priority, or lowering its priority. At block 950, it is determined if the user is finished. If not, block 940 repeats. When the user is finished at block 950, the system deletes shows when necessary at block 960 based on their priorities.

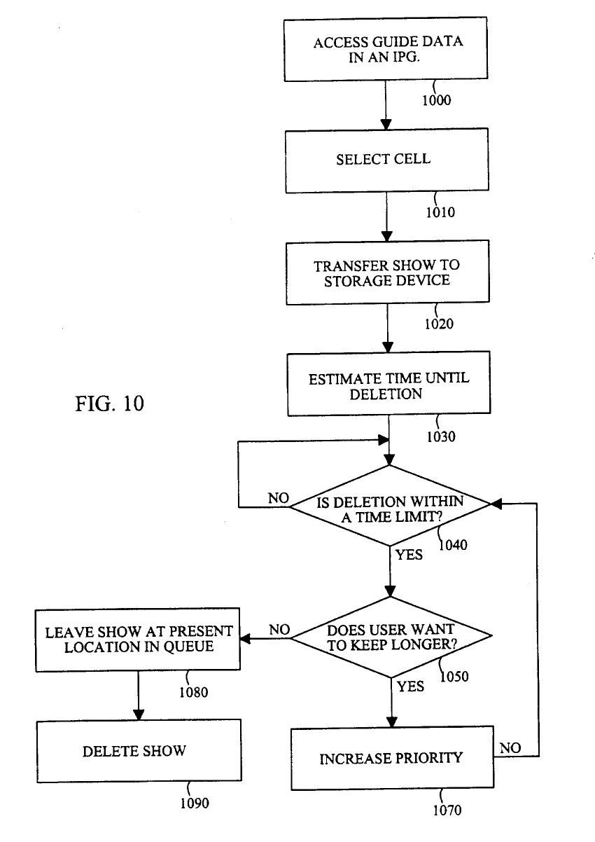

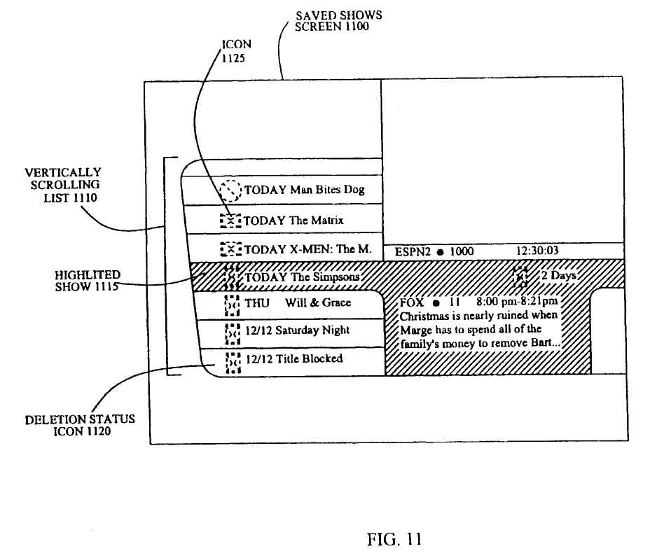

Another embodiment of the present invention uses a semi-automated process to control the contents of the disk, using a message or indication that allows the user to keep certain saved shows for a longer period of time, if desired. This embodiment is described in connection with the flowchart in FIG. 10. At block 1000, a user accesses guide data in the IPG using a GUI. At block 1010 the user selects a cell in the IPG corresponding to the program to be transferred to a storage device. At block 1020, the show is transferred to a storage device.

After the show is transferred, the system analyzes the amount of available disk space and the priority of each saved show and from this at block 1030 determines a date and time that each selected show to be transferred will eventually be deleted. At block 1040, the system determines if the eventual date and time for deletion for a show are within a limit (i.e., the show will be deleted in one hour). If not, then block 1040 repeats. When the limit is reached, then at block 1050, a process is initiated that allows the user to keep the show longer, if they so desire.

It is determined at block 1050 if the user wants to keep the show longer. If so, the system increases the priority of the show to where it is not the next show scheduled for deletion at block 1070, and block 1030 repeats. Otherwise, the show continues at its present location in the queue at block 1080 and it is eventually deleted at block 1090.

A saved shows screen is a component of the GUI used by one embodiment of the present invention. The screen may be accessed, for instance, by depressing a button on a remote control. The saved shows screen provides access to all shows that have been saved to the hard drive. FIG. 11 is an example of a saved shows screen. Saved shows screen 1100 includes a vertically scrolling list 1110 that displays the viewer's saved shows in reverse chronological order. By pressing up and down arrows on the remote, for instance, the viewer can scroll through the list and highlight a specific show 1115. Pressing play will begin the playback of the highlighted show 1115. A deletion status icon 1120 is used to give the user an estimate as to when a particular show will be deleted. In this example an icon 1125, which is a sideways hourglass is used to designate a show that is locked and cannot be deleted. While other icons are use hourglasses in different states to correspond to how long the shows have left before deletion and to give the user a quick visual perspective of the time until deletion.

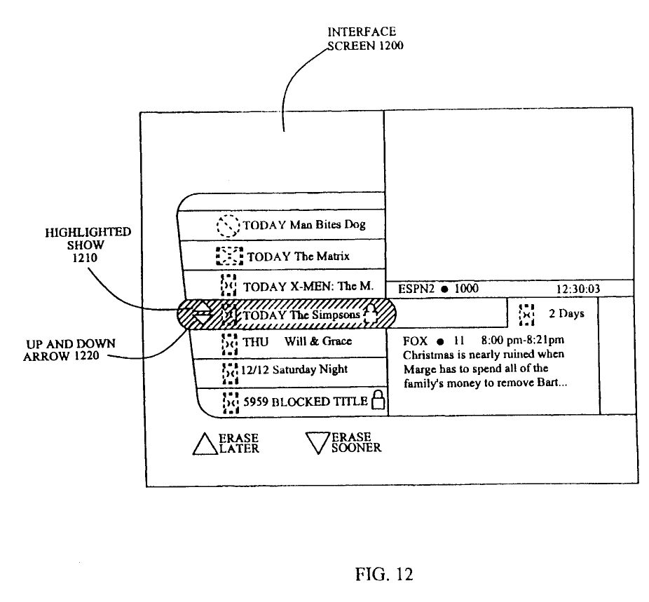

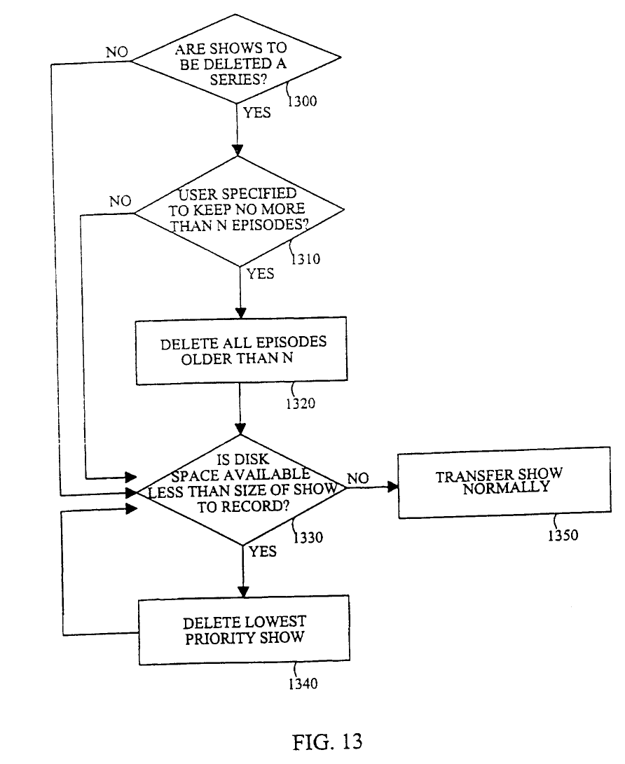

From screen 1100, the user may access a storage priority screen shown as 1200 of FIG. 12. Screen 1200 includes a highlighted show 1210 with up and down graphical arrows 1220. Up and down arrows 1220 correspond to buttons on a remote control, for instance. The user depresses these buttons to cause the highlighted show 1210 to move in the appropriate direction on the list. For instance, button 1230 is used to organize the list so that the highlighted show 1210 will be erased later. Likewise, button 1240 is used to organize the list so that the highlighted show 1210 will be erased sooner. The same functionality may also be achieved by dragging and dropping highlighted show 1210.

When highlighted show 1210 is moved at the user interface of screen 1200, the list is reorganized. In one embodiment, the list is handled in a data structure, such as a queue or an array wherein shows at the front of the queue are deleted first. In another embodiment, the system level list is maintained as a linked list. If a user accesses screen 1200 and drags and drops a show to a different location in the GUI, this causes the system to reorganize the list, either by manipulating pointers in the linked list or by sorting the array using the new priorities to harmonize the list with the action taken in the user interface of screen 1200.

When it is time for a show to be transferred to the storage device, the system ensures that there is sufficient disk space for such an operation. The following algorithm is used to clear sufficient disk space when the transfer starts, according to one embodiment of the present invention.

1. If the show belongs to a series, and the user has specified to keep no more than N episodes, any old episodes greater than N in number, are automatically deleted, regardless of whether the disk space is actually needed or not.

2. While the available disk space is less than what is needed to transfer the show: The lowest priority show is deleted. Shows which have been denoted as ‘locked for deletion’ are never deleted automatically.

FIG. 13 describes a disk space clearing algorithm according to one embodiment of the present invention. At block 1300 the system determines if one or more shows to be deleted are series. If so, it is determined at block 1310 if the user has specified to keep no more than N episodes. If so, then at block 1320, any old episodes greater than N in number, are automatically deleted, regardless of whether the disk space is actually needed or not.

If however, at block 1300 the shows are not a series, or at block 1310 the user has not specified to keep only N episodes, or after block 1320, it is determined if the available disk space is less than what is needed to transfer the show at block 1330. If so, the lowest priority show is deleted at block 1340 and block 1330 repeats. When block 1330 is false, transfer of the show is able to continue normally at block 1350, since enough space has been cleared from the disk.

According to one embodiment of the present invention, deletion priority is determined by the following system:

1. Saved shows are kept in a saved shows queue. As new shows are added to the queue, older recordings are moved towards the end of the queue. With the exception of shows that are marked as ‘locked for deletion’ saved shows at the far end of the queue have the lowest priority and are deleted first, when space is needed.

2. The user may manually move the position of a saved show in the saved show queue, thus changing its deletion priority.

3. The user may mark an individual show as ‘locked for deletion,’ in which case the show will not be deleted unless the user manually deletes it, or unlocks it (in which case the regular rules apply).

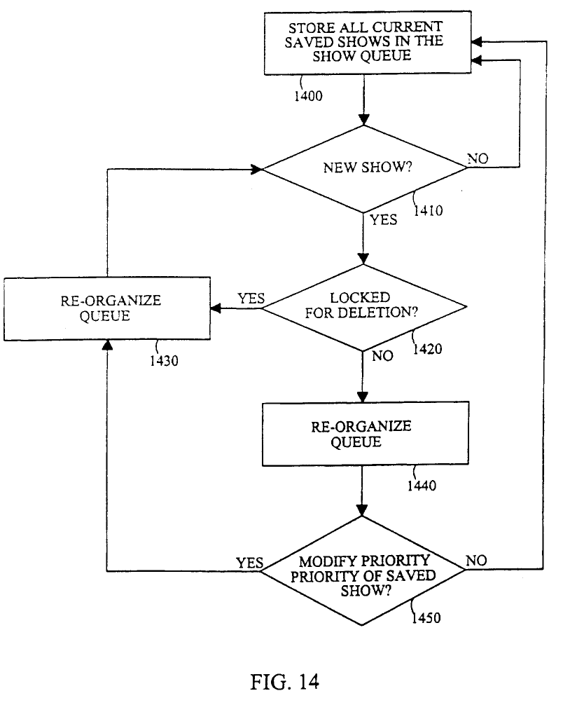

FIG. 14 is a flowchart showing one embodiment of a deletion priority algorithm. At block 1400 all of the current saved shows are stored in a saved show queue. At block 1410, it is determined whether a new show is being added to the saved show queue. If so, then at block 1420, it is determined if the show has been locked for deletion. If so, the list is reorganized at block 1430, wherein the show will not be deleted while it is marked locked for deletion.

If the show is not locked for deletion at block 1420, then at block 1440 the list is reorganized, wherein older shows are moved toward the end of the queue and the newest show is placed at the front of the queue. At block 1450, it is determined if the user is modifying the priority of a show in the saved show queue. This may occur, for instance, with a user explicitly assigning a new priority to the show, dragging and dropping the show to a different position in the saved show queue, or locking a specific show for deletion. If so, then block 1430 repeats. Otherwise, block 1400 repeats, where the system will wait until a new show is added to the queue and adjust the queue accordingly.

In one embodiment of the present invention, the user does not explicitly set a deletion date. Instead the user is required to move shows up and down the saved show queue to change the show's deletion priority. Shows closer to the bottom (end) of the queue are deleted first, unless they are locked for deletion.

The following algorithm is used to estimate the time that remains before a particular show will be deleted. This algorithm is used to give the user an idea as to the effect of repositioning the show in the saved show queue. The algorithm simulates of the process of transferring the show to a storage device, and uses a heuristic to approximate the deletion time for shows, which may be deleted too far in the future to guess accurately.

Below is pseudo-code showing one way to implement the time until deletion algorithm:

Let S=the free space on the disc;

Let I=the last (bottom) recording in the saved show queue.

For each show X in the schedule queue

Let D=the planned start time of a transfer X

If the show X is from a series, and the series settings indicate that

no more than N episodes should be kept:

For each remaining series episode (J) over N in number,

Let show J's estimated deletion time to D.

Subtract the required discspace of X from S.

While S<0:

If show I is locked, or the estimated deletion time has already been set, ignore show I

Otherwise,

Set show I's estimated deletion time to D

Add show I's duration to S.

Set I to the previous show in the saved show queue.

If there are no more shows, break out of the X loop.

Let G=A running average of the time between estimated deletions in G.

For all the remaining recordings (I) for which we have not made estimates.

D=D−G

Set show I's estimated deletion time to D

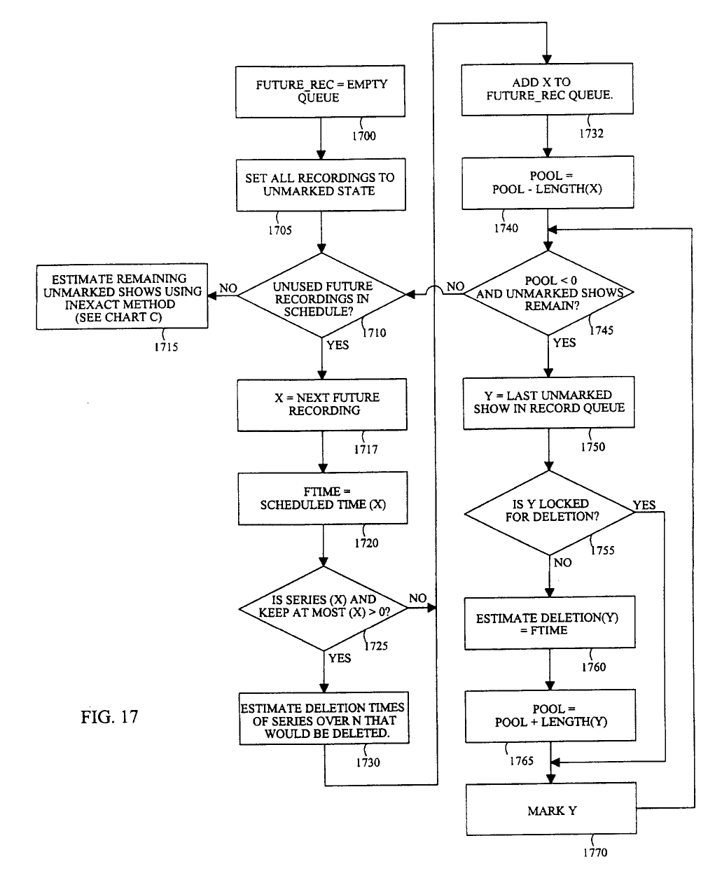

FIG. 17 is a flowchart showing how an estimated time for deletion is obtained. It is a precise method using simulation of future shows that will be transferred to the storage device by the system (for instance using an automatic series manager process). This is important because when a user schedules a new show for the future, there may be one or more automatic transfers that take place before the new show is eventually transferred. These intervening automatic transfers change the available disk space that will be available. Similarly, the user usually sets a maximum number of episodes to be transferred in a series, so there may also be intervening automatic deletions of surplus episodes that change the available disk space that will exist at the time the new show is transferred to the storage device.

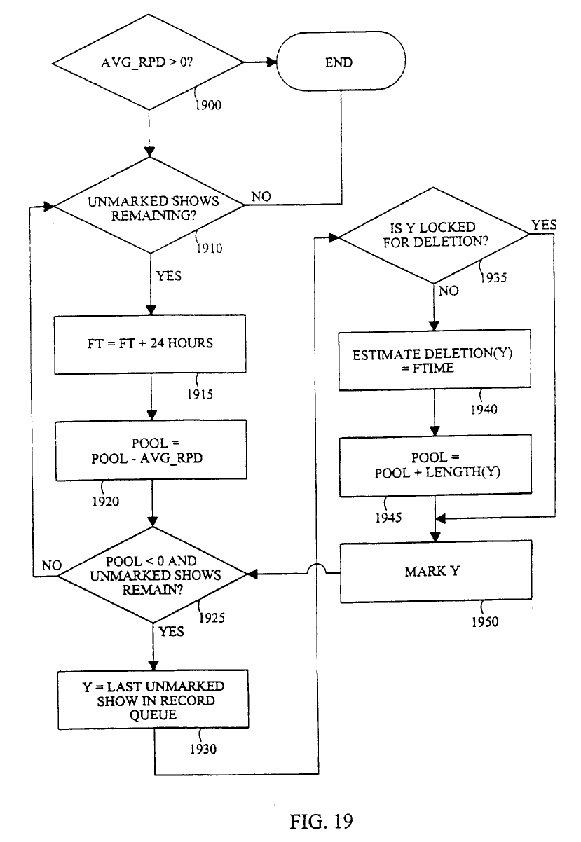

The precise estimated time until deletion algorithm of FIG. 17 takes intervening transfers and deletions into account by simulating the future transfers and deletions up until the time the scheduled show will be transferred. This precisely determines if and when a saved show will need to be deleted to free available disk space for the scheduled show. The process starts at block 1700 where a future recording queue (i.e., simulated recordings) is initialized to an empty queue. At block 1705 all recordings are set to an unmarked state. At block 1710, it is determined if there are any unused future recordings in the schedule. If not, then all of the recordings on the disk will remain there until a future event occurs, such as a user manually recording a new show or setting up an automatic recording process, which might fill the disk at some point in the future. In this case, the only way to estimate the time until deletion is using an inexact method at block 1715 and the process is complete. The inexact method might, for instance, take an average of how many hours per day the user typically records and use that average to determine when the disk will fill up and based on that it can approximate when a show will be deleted. The inexact method is described in further detail in FIG. 19.

If, however, at block 1710 there are unused future recordings in the schedule, the next future recording is set to (X) at block 1717. The future time to estimate is set to the schedule time of X at block 1720. At block 1725, it is determined if X is a series and if the user has specified to only keep a certain number of episodes (N) of this series. If so, then at block 1730, an algorithm is initiated to estimate the time until deletion of all of the series episodes greater than N. Then, X is added to the future record queue at block 1732, which also occurs after block 1725 if X is not a series. Then a pool corresponding to the available disk space has the length of show X subtracted at block 1740.

At block 1745, it is determined if the pool is less than 0 and any unmarked shows remain. If not, then there is enough disk space and no more shows to record, so the flow proceeds to block 1710 where the process waits for more future shows to estimate and repeats. Otherwise, after block 1745 a loop is initiated between blocks 1750-1770 where the last unmarked show has its deletion simulated and the process repeats until the pool rises above 0. The loop starts at block 1750 where the last unmarked show in the future recording queue is set to (Y). At block 1755, it is determined if Y is locked for deletion. If not, then the future time of Y's deletion is estimated at block 1760 and the pool has the length of show Y added to it. If block 1755 is false, or after block 1760, Y is marked and the process repeats at block 1745.

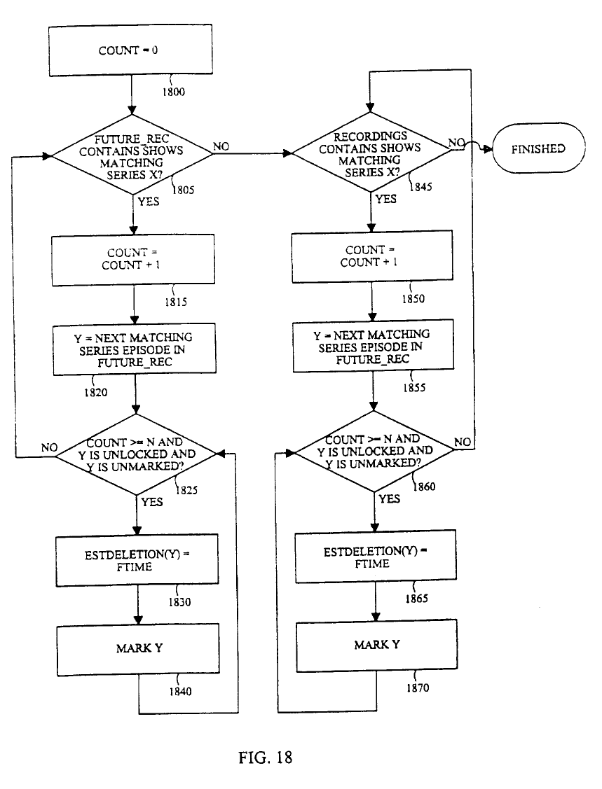

FIG. 18 is a flowchart showing how one embodiment of the present invention handles estimating the deletion of a series including automatic deletion of surplus episodes. This occurs, for instance, at block 1730 of FIG. 17. It is necessary to perform this process when estimating the deletion times of shows and one or more automatic series transfers are included in the future recordings queue. This means that in the future some series will be recorded and possibly some surplus episodes will be deleted. Taking these activities into account are necessary to predict how much disk space will be available when a show is actually recorded.

The process begins at block 1800 where a count is set to 0. At block 1805, it is determined if a future recording queue (a list of simulated future recordings) contains shows matching the series (X) (where X is set to a series episode that is going to have its recording simulated). If so, then count is incremented by 1 at block 1815. At block 1820, (Y) is set to the next matching series episode in the future recordings queue. At block 1825, it is determined if the count is greater than or equal to (N) (where N is the number of series episodes the system is allowed to keep) and Y is unlocked and unmarked. If not, then block 1805 repeats. Otherwise, the future time is set to the estimated deletion time of Y at block 1830, Y is marked at block 1840, and block 1825 repeats.

When block 1805 eventually becomes false, it is determined at block 1845 if any recordings match series X. If not, then the algorithm is finished. Otherwise, at block 1850, count is incremented by 1. At block 1855, Y is set to the next matching episode in the future recordings queue. At block 1860 it is determined if count is greater than or equal to N and Y is unlocked and unmarked. If not, then block 1845 repeats. Otherwise, the future time is set to the estimated time of deletion for Y at block 1865, Y is marked at block 1870, and block 1860 repeats.

FIG. 19 is a flowchart showing how one embodiment of the present invention handles estimating the deletion times when only an inexact method can be used. This occurs, for instance, at block 1715 of FIG. 17. It is important to use this algorithm when there are no recordings in the future recording queue and the disk is not full. In this scenario, the only way to estimate a show's deletion time is to estimate the speed in which the disk will fill up based on the user's pattern of activity. For instance, if a user records 3 hours of shows per day on average, than this value can be used to estimate when the disk will fill up, and consequently when shows will need to be deleted.

The process begins at block 1900 where it is determined if the average recordings per day exceed zero. The average recordings per day (avg_rpd) are found, for instance, by taking the total length of all shows in the schedule and dividing it by the total number of days in the schedule. This gives a space/time figure. For instance, if the recording schedule has 6 hours of shows over a period of 3 days, the avg_rpd is set to 2 hours. If the avg_rpd equals zero the process is complete. Otherwise at block 1910, it is determined if any unmarked shows remain. If not, the process is complete.

If unmarked shows remain, then at block 1915, the future time is set ahead by 24 hours. At block 1920, the pool of available disk space has the avg_rpd subtracted from it. At block 1925, it is determined if the pool is less than zero and any unmarked shows remain. If not, then block 1910 repeats If block 1925 is true, then at block 1930 (Y) is set to the last unmarked show in the record queue. At block 1935 it is determined if Y is locked for deletion. If not, then at block 1940 the future time to start estimating is set to the estimated time of deletion for Y. At block 1945 the pool of available disk space has the length of show Y added to it. At block 1950, Y is marked and block 1925 repeats. If block 1935 was true, then Y is marked at block 1950 and block 1925 repeats.

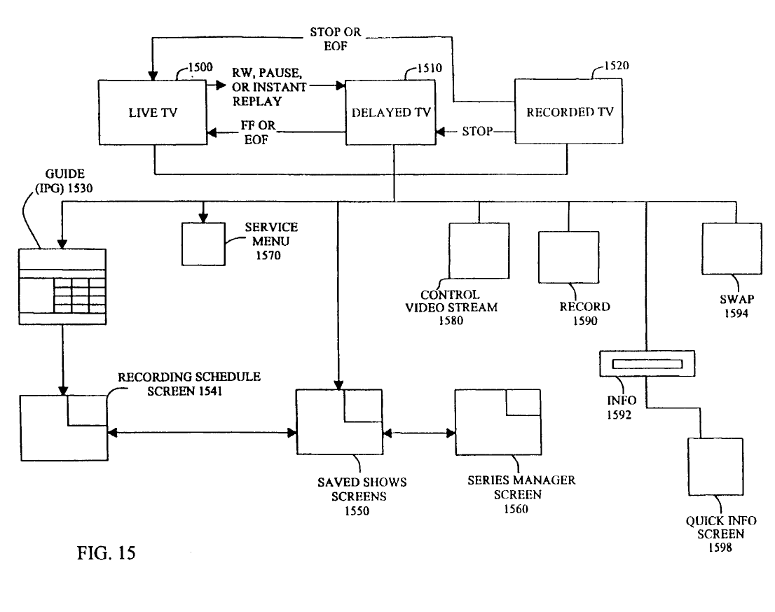

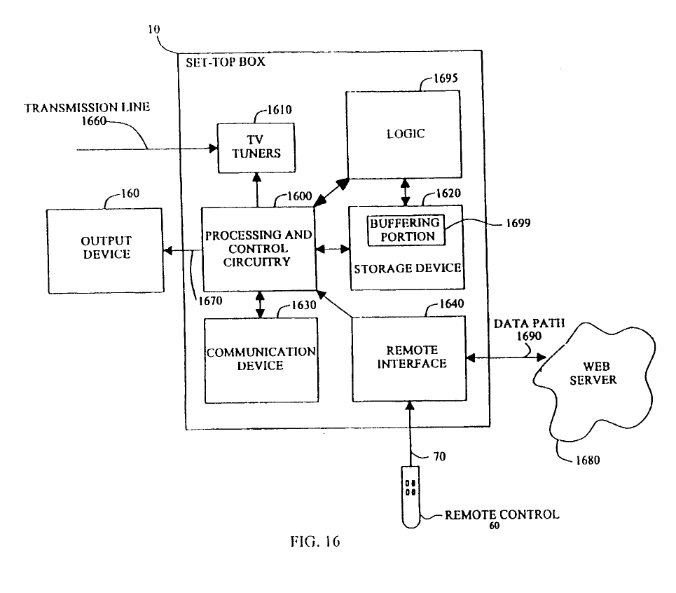

The overall system used by the present invention allows a user to transfer shows to a storage device, manage a library of saved programs, apply VCR-like functionality to TV programming, and view television in a time shifted mode. FIG. 15 is a flowchart that provides an overview of the screens, menus, and functions that are provided for the user. Blocks 1500, 1510, and 1520 are for live television, delayed television, and recorded television respectively. The broadcast signal comprises the live television input to the system. Delayed television block 1510 shows the viewer the broadcast signal that is offset from real time and displayed from a cache. Recorded television block 1520 is used to show a pre-recorded program that is displayed from the disk. The user may rewind, pause, or perform an instant replay on the live signal, as well as fast forwarding the signal, which causes the system to adjust the video stream accordingly.

From the main screens 1500-1520, the user may invoke an interactive program guide 1530, which allows them to browse program information, select and display programs, and set up single instance and series recordings. To this end, a recording schedule screen 1540 may be invoked to review a scheduled recording's information, cancel scheduled recordings, change recording priorities, change recording parameters, and schedule manual recordings. A saved shows screen 1550 may also be invoked, whether from recording schedule screen 1540 or from main screens 1500-1520. The saved shows screen lets the user review a pre-recorded program's information, play pre-recorded programs, archive pre-recorded programs, change storage priorities, delete pre-recorded programs, and schedule manual recordings.

From saved shows screen 1550, a series manager screen 1560 may be invoked. The series manager screen shows a list of scheduled series recordings and allows the user to review a series” recording information, cancel series recordings, change series recording priorities, change series recording parameters, and schedule manual series recordings. From main screens 1500-1520 the user may also invoke a service menu 1570 to launch applications, control the video stream 1580, either by fast forward, rewind, stop, play, instant replay, etc., record 1590, obtain additional information 1592 and perform a swap, 1594.

If the user performs a swap 1594 the display foreground and background tuners are swapped. If the user prompts the system for more information 1592, a channel banner with a timeline 1596 is invoked. The channel banner provides a brief summary of information about the show, such as the time left, the title, the channel, etc. If the user requires more information that the channel banner shows, they may initiate a quick information screen 1598 that displays additional information.

FIG. 16 is a functional block diagram that illustrates the components of an embodiment of the present invention. Note that FIG. 16 is intended to be a conceptual diagram and does not necessarily reflect the exact physical construction and interconnections of these components. Set-top box 10 includes processing and control circuitry 1600, which controls the overall operation of the system. Coupled to the processing and control circuitry 1600 are one or more TV tuners 1610, a storage device 1620, a communication device 1630, and a remote interface 1640.

Tuners 1610 receive the television signals on transmission line 1660, which may originate from an antenna, a cable television outlet, or other broadcast input source. The set-top box 10 may have any number of tuners in block 1610. This includes, for instance, multiple tuners in a single box or the sharing of tuners between several interconnected set-top boxes (not shown). Processing and control circuitry 1600 provides audio and video output to output device 160 via a line 1670. Remote interface 1640 receives signals from remote control 60 via wireless connection 70. Communication device 1630 is used to transfer data between set-top box 10 and one or more remote processing systems, such as a web server 1680, via a data path 1690.

Processing and control circuitry 1600 may include one or more of devices such as general-purpose microprocessors, digital signal processors, application specific integrated circuits, various types of signal conditioning circuitry, including analog-to-digital converters, digital-to-analog converters, input/output buffers, etc. Storage device 1620 may include one or more physical memory devices, which may include volatile storage devices, nonvolatile storage devices, or both. For example, storage device 1620 may include both random access memory (RAM), read-only memory (ROM), hard disk drives, various forms of programmable and/or erasable ROM, flash memory, or any combination of these devices.

Communication device 1630 may be a conventional telephone modem, an Integrated Services Digital Network adapter, a Digital Subscriber Line (xDSL) adapter, a cable television modem, or any other suitable data communication device. Logic 1695 typically resides in storage device 1620. Logic 1695 may be used when the video recorder has been given instructions to transfer a show to the storage device and there is insufficient space on the storage device to perform such an action.

According to an embodiment of the present invention, the core user interface screens comprise a saved shows screen, a recording schedule screen, and a series manager screen. Typically, a video recorder has an interface that might provide some of the features of the core user interface screens of the present invention, but they are used in a hierarchical manner. For instance, the user interface might comprise a home screen, from where a user might move to a saved shows screen or to a recording schedule list. The recording schedule list might allow the user to proceed to a to-do list or a season pass screen.

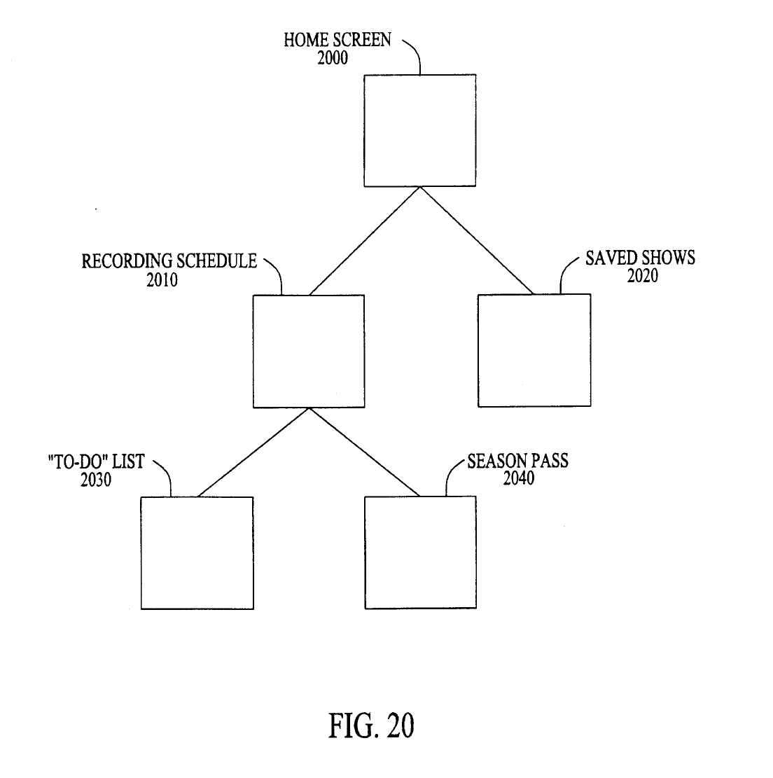

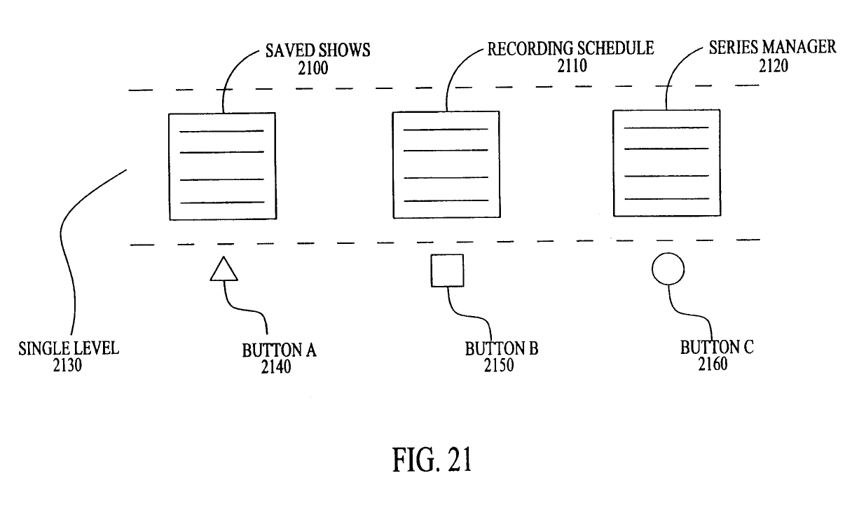

FIG. 20 shows an example of a typical hierarchical user interface. Home screen 2000 allows the user to access a recording schedule screen 2010 or a saved shows screen 2020. The recording schedule screen 2010 allows the user to access a to-do list 2030 or a season pass list 2040. To move between screens in FIG. 20 requires at least one keystroke on an input device such as a remote control. Therefore, to move from home screen 2000 to do list 2030 requires at least two keystrokes and two screens to be viewed by the user. To move from to-do list 2030 to saved shows screen 2020 requires at least three keystrokes and three screen views. Such a scheme wastes the systems resources and the user's time, energy, and patience. There is a limit for most users as to how intricate a user interface can be before the user chooses not to use the interface at all. Using hierarchical interface screens pushes this limit. Therefore, it is desirable to have a user interface that requires the minimum number of user actions to perform the functions of the user interface.

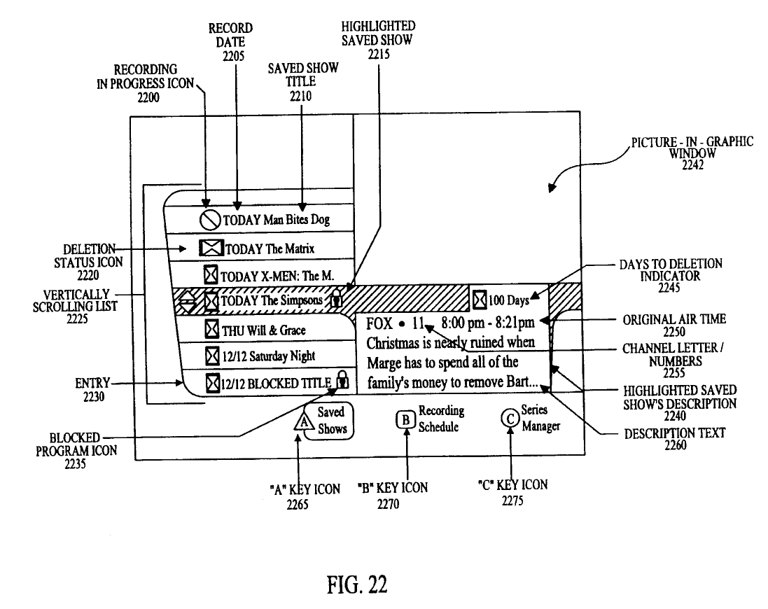

FIG. 21 shows a non-hierarchical interface for the core user interface screens according to an embodiment of the present invention. The non-hierarchical interface screens of FIG. 21 are easier to navigate than traditional hierarchical interface screens and require less keystrokes inputs to move between the screens. Saved shows screen 2100, recording schedule screen 2110, and series manager screen 2120 are shown at a single level 2130. Buttons A 2140, B 2150, and C 2160 are used to symbolically represent a users keystrokes, for instance via a remote control. One sees from FIG. 21, that a user can move between screens 2100-2120 using only a single keystroke. For instance, if the user is viewing screen 2100, and depresses button C 2160, series manager screen 2120 is immediately displayed. Likewise, if user is viewing screen 2120 and depresses button B 2150, screen 2110 is immediately displayed.

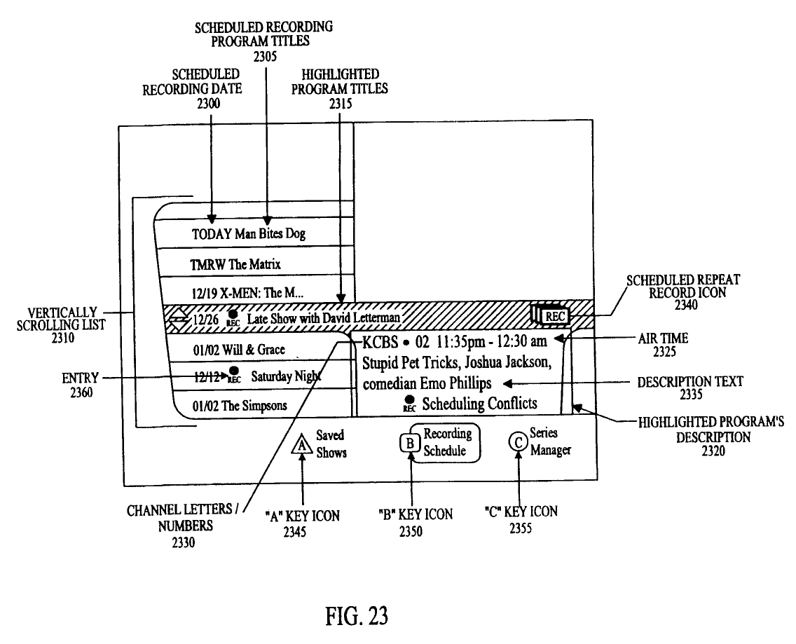

FIGS. 22, 23, and 24 show more detailed examples of screens 2100-2120 of FIG. 21. FIG. 22 shows a saved shows screen according to one embodiment of the present invention. The saved shows screen includes shows that have been saved in the past and shows that are actively being transferred to the storage device. The saved shows screen includes a recording in progress icon 2200, in this embodiment, displayed to the left of shows that are currently being transferred to the storage device. Each entry has a record date 2205. The record date according to one embodiment is displayed in a DD/MM format. If a show was transferred within seven days of the current day, the show's record date is replaced with a three-letter abbreviation for the day on which it was transferred. If the transfer occurred on the current day, the record date 2205 will be replaced with today.

Each show also has a title 2210. The title of the saved show appears in a vertically scrolling list 2225. Titles that exceed the width of the title column are truncated in one embodiment of the present invention. As truncated titles are highlighted, they expand to fill the empty space to the right of the list 2225. A highlighted saved show 2215 is currently shown as The Simpsons. In one embodiment, the highlighted saved show 2215 is displayed in white, to differentiate it from other shows in vertically scrolling list 2225. If the show's title is truncated in the list due to space constraints, the title is expanded into the blank area above the show's description text 2260.

Each entry has a deletion status icon 2220. In one embodiment, deletion status icons appear in the vertically scrolling list 2225 to the left of each show's record date 2205 and represents the amount of time a show is expected to remain on the hard drive (or other storage device) before it is automatically deleted to make room for future recordings. In one embodiment, the deletion status icons 2220 are hourglass shapes. An hourglass shape on its side represents a show that cannot automatically be deleted. No icon represents a show that may be automatically deleted, if necessary, but deletion is not expected to occur within X number of days, where X is a changeable number of days. An hourglass with varying levels of sand inside represent varying levels of time that a show has left before it is automatically deleted.

Entry 2230 is shown as having a blocked program icon 2235, which keeps unauthorized users, such as children, from viewing information about the saved show. In one embodiment, the blocked program icon 2235 appears to the right of each title and requires a PIN entry to begin playback. The highlighted saved show 2215 includes a highlighted saved show description area 2240. In one embodiment, the highlighted saved show description area 2240 appears on the right side of the screen below a picture in graphic window 2242 and includes a days to deletion indicator 2245, an original air time 2250, channel letters and numbers 2255, and a description text 2260.

The days to deletion indicator 2245 provides the user with an estimate of the amount of time left until a program is deleted. The estimate may be in days, hours, etc. The original air time 2250 displays the time slot in which the highlighted show originally aired. In one embodiment, if a show was only partially recorded, the air time 2250 is replaced with the start and end times of the recording and the type will be presented in a color that differentiates it from other full recordings. An A icon 2265, a B icon 2270, and a C icon 2275 are shown to correspond with buttons on an input device, such as a remote control, which the user may depress to immediately access another core user interface screen with a single keystroke.

FIG. 23 shows a recording schedule screen according to an embodiment of the present invention. The recording schedule screen is configured to provide the user with information about what shows are scheduled to be transferred to the storage device in the future. The screen includes a scheduled recording date 2300 and the title of the scheduled recording 2305 arranged in a vertically scrolling list 2310. In this embodiment, the vertically scrolling list 2310 displays individual scheduled recordings in reverse chronological order. Typically, upon entering this screen, the recording at the top of the list (which will occur soonest) is highlighted. If a listed scheduled recording cannot be recorded due to tuning conflicts, it will be grayed out and a no record icon 2360 will be displayed to the left of its title according to one embodiment.

Each row in the vertically scrolling list contains the scheduled recording date 2300 and the scheduled recording program titles 2305. The scheduled recording date 2300 is displayed in a DD/MM format. Scheduled recordings that will occur on the current day are identified with the label TODAY instead of the current date. Similarly, scheduled recordings that will occur on the day after the current day are identified with the label TMRW. The scheduled recording program title 2305 also appears in the vertically scrolling list 2310. Titles that exceed the width of the title column are truncated. As truncated titles are highlighted, they expand to fill the empty space to the right of the list.

When a user highlights a program title 2315, the scheduled recording is visually differentiated from the rest of the list. Highlighted title 2315 is shown as having been expanded after being truncated due to space constraints. A highlighted program description area 2320 provides information about the air time of the show 2325, channel letters and numbers, 2330, and a description text 2335. It also includes a scheduled repeat record icon 2340. Icon 2340 indicates that that particular show is scheduled to be transferred to the storage device repeatedly every time it airs or on a regular basis.

Recordings that have been scheduled but will not be recorded due to conflicts (bumped shows) are displayed in the list 2310, but are visually differentiated from shows that will be recorded. For instance, show 2360 has a no record icon 2365 and has a visual differentiation. A key icon 2345, B key icon 2350, and C key icon 2355 are visible in a lower portion of the screen. These keys 2345-2355 are used to access the other core interface screen with the touch of one button. Each key 2345-2355 corresponds to a key on a remote control.

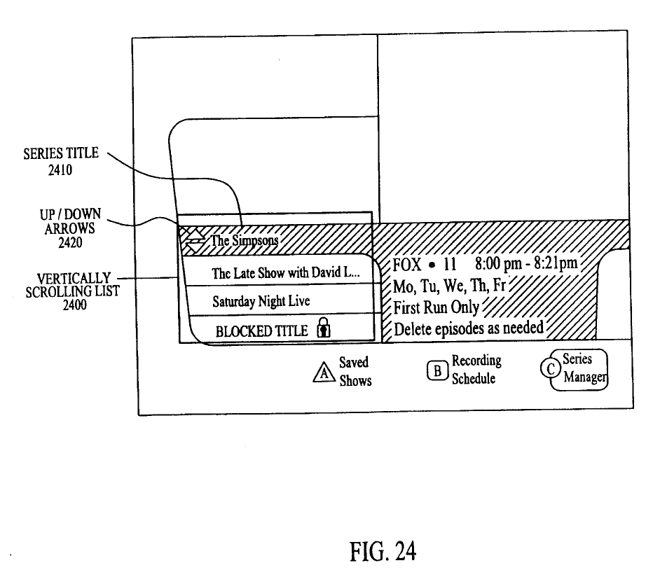

FIG. 24 shows a series manager screen according to one embodiment of the present invention. The series manager screen is used to display the shows that will be repeatedly transferred to the storage device under certain conditions. For instance, the user might transfer a certain timeslot to the storage device every time or the user might transfer a certain show to the storage device every time, regardless of the channel or timeslot. Occasionally, scheduled series recordings may cause tuner conflicts that prevent one or more recordings from occurring. The series manager allows the viewer to assign priorities to series recordings so that when tuner conflict occur, the system is able to determine which recordings take precedence. The series manager also allows the user to modify the recording parameters of individual series or delete a series from the recording queue. The series manager may be viewed in two modes according to one embodiment of the present invention. A first mode is a browse mode. A second mode is a prioritize mode. The browse mode allows a user to see the list of series recordings and to select a series to modify. The prioritize mode allows the viewer to change the priority with which a selected series will be recorded.

The screen of FIG. 24 is in browse mode. In browse mode the user has a vertically scrolling list 2400. The list 2400 displays the user's scheduled recordings. Titles for the series 2410 are displayed in order of priority (in the event of a conflict). Instances of a series that are most likely to be recorded in the event of a conflict appear at the top of the list, while least likely recordings appear toward the bottom of the list. Pressing up/down arrows 2420, which correspond to buttons on a remote control, for instance, allows the viewer to scroll through the list and highlight a specific series. Selecting a series allows the user to change recording and priority parameters.

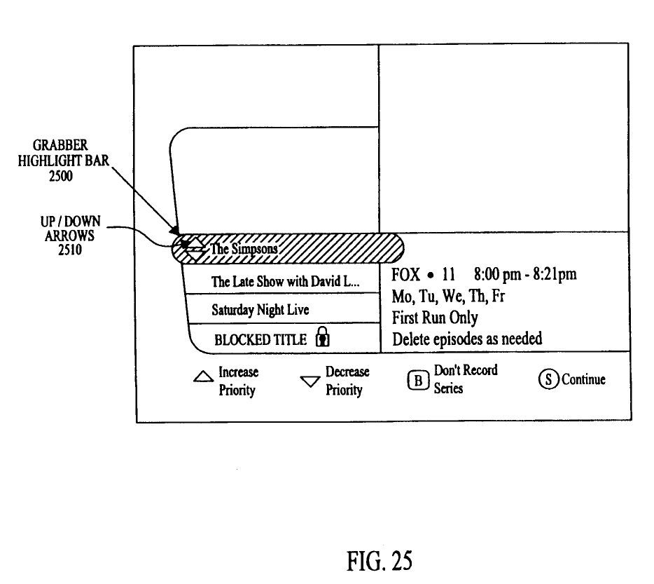

FIG. 25 shows a series manager screen in prioritize mode according to one embodiment of the present invention. Prioritize mode includes a grabber highlight bar 2500. The grabber highlight bar 2500 becomes a floating grabber when this screen is invoked. Using up/down arrow keys 2510, for instance, the user changes the priority of the selected series. This is termed a priority picker by one embodiment of the present invention. By using the GUI to pick a show and move it elsewhere in the list, the priority of the show is changed, which in turn changes the way the system resolves conflicts (i.e., a higher priority show is more likely to be given access to a tuner in a resource starved environment).

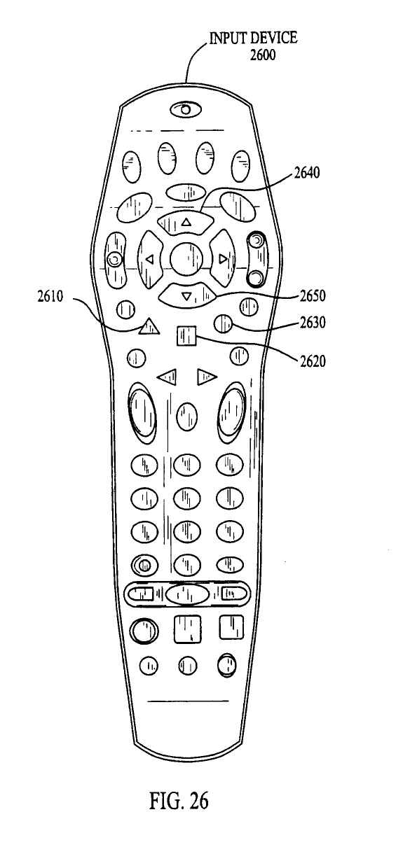

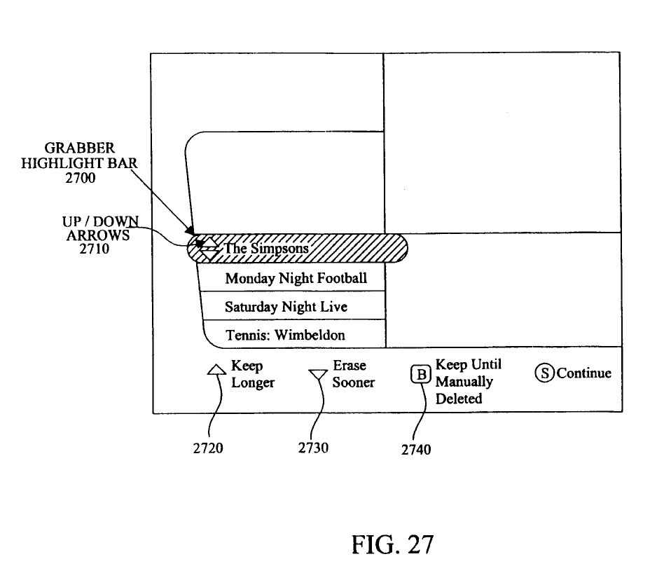

A priority picker is also implemented in a saved shows screen. In the saved shows screen, the priority picker changes a shows deletion priority, which in turn changes the time when the show will eventually be removed from the storage device. FIG. 27 shows an embodiment of a priority picker for a saved shows screen. A grabber highlight bar 2700 is used as in FIG. 26, which may become floating, if initiated. Up/down arrows 2710 correspond to arrows on an input device. Using the up arrow results in keeping the show longer 2720. Using the down arrow results in erasing the show sooner 2730. Alternatively the user can keep the show until manually deleted 2740. By using the up/down arrows 2710 the user internally changes the priority of the show which allows the system to determine when the show will automatically need to be erased.

In one embodiment of the present invention, visual indications are used to easily associate buttons on an input device, such as a remote control, with screens that are accessed by pressing the buttons. For instance, the A, B, and C buttons on the remote control might be red, blue, and yellow, in conjunction with their associated screenshots being bordered by the same colors and by the buttons on the screen having the same colors. In another embodiment, each key has a unique shape that corresponds to a shape also shown on the UI screens. For instance, one button may be a triangle, another a circle, and another a square.

FIG. 26 shows one embodiment of an input device that is used by the present invention. Input device 2600 includes an A key 2610, a B key 2620, and a C key 2630. Keys 2610-2630 are input points, where the user is able to depress the key, which provides input to the system and causes the system to perform an action. Input device 2600 also includes up arrow key 2640 and down arrow key 2650. In this embodiment, keys 2610-2630 are easily identifiable to the user because their shape corresponds to a shape shown on the core user interface screens. For instance, key 2610 is a triangle, key 2620 is a square, and key 2630 is a circle. The keys 2610-2630 may alternatively be color coded, or both cues (shape and color) may be used together.

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. A method for accessing one or more interface screens associated with a video recorder, comprising: providing one of said interface screens; providing an input device having one or more input points; associating each of said input points with each of said interface screens; and accessing any of said one or more interface screens by actuating one of said input points with a single keystroke.

2. The method of claim 1 wherein said input device is a remote control.

3. The method of claim 2, wherein said input points are buttons on said remote control.

4. The method of claim 1 wherein said input device is an interface connected to a set-top box.

5. The method of claim 1 wherein said interface screens include a series manager screen, a recording schedule screen, and a saved shows screen.

6. The method of claim 1 wherein said input points are associated with a color and said associated interface screens are also associated with said color.

7. The method of claim 1 wherein said input points are associated with a shape and said associated interface screens display said shape.

8. A computer program product comprising: a computer usable medium having computer readable program code means embodied therein for enabling access to one or more interface screens associated with a video recorder, comprising: computer readable program code means for causing a computer to provide one of said interface screens; computer readable program code means for causing a computer to provide an input device having one or more input points; computer readable program code means for causing a computer to associate each of said input points with each of said interface screens; and computer readable program code means for causing a computer to enable access to any of said one or more interface screens by actuating one of said input points with a single keystroke.

9. The computer program product of claim 8 wherein said input device is a remote control.

10. The computer program product of claim 9 wherein said input points are buttons on said remote control.

11. The computer program product of claim 8 wherein said input device is an interface connected to a set-top box.

12. The computer program product of claim 8 wherein said interface screens include a series manager screen, a recording schedule screen, and a saved shows screen.

13. The computer program product of claim 8 wherein said input points are associated with a color and said associated interface screens are also associated with said color.

14. The computer program product of claim 8 said input points are associated with a shape and said associated interface screens display said shape.

15. An arrangement of interface screens associated with a video recorder, comprising: an input device having at least a first, a second, and a third input point; a first interface screen associated with said first input point; a second interface screen associated with said second input point; and a third interface screen associated with said third input point, wherein a user is able to access any of said first, second, and third interface screens by actuating any one of said input points with a single keystroke.

16. The arrangement of claim 15 wherein said input device is a remote control.

17. The arrangement of claim 16, wherein said input points are buttons on said remote control.

18. The arrangement of claim 15 wherein said input device is an interface connected to a set-top box.

19. The arrangement of claim 15 wherein said interface screens include a series manager screen, a recording schedule screen, and a saved shows screen.

20. The arrangement of claim 15 wherein said input points are associated with a color and said associated interface screens are also associated with said color.

21. The arrangement of claim 15 wherein said input points are associated with a shape and said associated interface screens display said shape.

22. An apparatus comprising: a user interface; a saved show screen; a recording schedule screen; and a series manager screen, wherein said user interface is configured to display said saved show screen, said recording schedule screen, and series manager screen at a single level.

23. The apparatus of claim 22, further comprising a user input device configured so that a user moves between said screens using a single keystroke.

24. The apparatus of claim 22, further comprising: a video recorder for recording one or more shows; and a local storage configured to store one or more of said shows.

25. The apparatus of claim 24, wherein said saved show screen displays information on said recorded and stored shows.

26. The apparatus of claim 24, wherein said saved show screen displays a recording in progress icon.

27. The apparatus of claim 24, wherein said recording schedule screen displays information on shows to be recorded in the future.

28. The apparatus of claim 24, wherein said series manager screen displays information on one or more shows that will be repeatedly transferred to said local storage under conditions.
